(19) United States
(12) Patent Application Publication
(10) Pub. No.: US 2025/0374888 A1
(43) Pub. Date: Dec. 11, 2025

(54) CAT LITTER BOX

(71) Applicant: Dongguan ZhiYiHong Hardware & Plastic Co., Ltd., Dongguan (CN)

(72) Inventor: Zhiqi Xue, Dongguan (CN)

(73) Assignee: Dongguan ZhiYiHong Hardware & Plastic Co., Ltd., Dongguan (CN)

(21) Appl. No.: 19/206,197

(22) Filed: May 13, 2025

(30) Foreign Application Priority Data
Jun. 11, 2024 (CN) 202421308572.1

(51) Int. Cl. A01K 1/01

(52) U.S. Cl. CPC A01K 1/0114

(57) ABSTRACT

A cat litter box includes a box body, a cleaning assembly and a poop basin; the cleaning assembly is connected to the box body, the poop basin is adjacent to the box body, and the cleaning assembly is configured to move towards the poop basin along the end, far away from the poop basin, of the box body; during moving, the cleaning assembly will filter cat litter in the box body; the poop basin is provided with a movably connected poop basin cover; when moving close to the poop basin, the cleaning assembly will be abutted against the poop basin cover, and the poop basin cover will be driven to be gradually opened as the cleaning assembly moves towards the poop basin; and when the cleaning assembly moves towards the end, far away from the poop basin, of the box body, the poop basin cover will be gradually closed.

### FIELD OF THE INVENTION

The present application relates to the technical field of pet supplies, and particularly relates to a cat litter box.

### BACKGROUND OF THE INVENTION

In related technology, cat litter boxes are usually arranged as box-like structures that can accommodate more cat litter; after excreting in the box, some cats will pull the cat litter with paws to bury the poop, but some undomesticated cats may not bury the poop; and whether buried or not, the cat poop will produce odors, and it needs breeders to use tools to filter the cat poop out of the cat litter in time. That is, it is needed to manually clean the cat litter in most of the existing cat litter boxes, which easily causes discomfort of breeders in smell or vision during cleaning.

### SUMMARY OF THE INVENTION

The present invention provides a cat litter box, aiming to solve the problems that an existing cat litter box needs to be manually cleaned, which is tedious to operate and easily causes discomfort of breeders during operation.

In order to achieve the above object, the present invention provides the following technical solutions:
a cat litter box, comprising a box body, further comprising a cleaning assembly and a poop basin, wherein the cleaning assembly is connected to the box body, the poop basin is adjacent to the box body, and the cleaning assembly is configured to move towards the poop basin along the end, far away from the poop basin, of the box body; during moving, the cleaning assembly filters cat litter in the box body; and
the poop basin is provided with a movably connected poop basin cover, and when the cleaning assembly moves close to the poop basin, the cleaning assembly is abutted against the poop basin cover, and then the poop basin cover is driven to be gradually opened as the cleaning assembly moves towards the poop basin; and when the cleaning assembly moves towards the end, far away from the poop basin, of the box body, the poop basin cover is gradually closed.

Further, the poop basin cover comprises a covering portion and an abutting portion; the covering portion is movably connected to the poop basin; and one end of the abutting portion is connected to the covering portion while the other end thereof is used for abutting against the cleaning assembly.

Further, when the poop basin cover is closed, the abutting portion protrudes out of the poop basin.

Further, the poop basin comprises a poop basin frame and a poop basin body, the poop basin cover is connected to the poop basin frame, and the poop basin body is detachably connected to the poop basin frame.

Further, the cleaning assembly is provided with door opening arc walls which are used for being abutted against the poop basin cover.

Further, the cleaning assembly comprises a driving mechanism and a scraper knife member connected to the driving mechanism; and the driving mechanism is used for driving the scraper knife member to move, so that the scraper knife member can filter the cat litter in the box body during moving.

Further, the door opening arc walls are arranged on two sides of the scraper knife member, and are higher than the scraper knife member.

Further, the scraper knife member is provided with a first scraper knife portion which is abutted against the box body; and in the process that the driving mechanism drives the scraper knife member to move, the first scraper knife portion fits an upper surface of the box body to move.

Further, the cat litter box further comprises a shell, in which rails are arranged on the shell which is in sliding connection with the driving mechanism by sliding rail members; and the driving mechanism is configured to be capable of reciprocating along the rails.

Further, racks are arranged in the rails, and the sliding rail members are arranged to be gears in meshed connection with the racks.

Further, the bottoms of the rails and the bottom of the box body are both in an arc shape, and the rails and the box body have the same bending radian and are corresponding in position.

Further, the scraper knife member is rotationally connected to the driving mechanism, and a torsion structure is arranged at a joint of the scraper knife portion and the driving mechanism; a first limiting wall is arranged at one end of the scraper knife member, and a second limiting wall is correspondingly arranged on the driving mechanism; the first limiting wall can be abutted against the second limiting wall when the scraper knife member rotates relative to the driving mechanism; and the direction in which the first limiting wall abuts against the second limiting wall is opposite to the torsion direction of the torsion structure.

Further, the torsion structure is a torsion spring.

Further, the cat litter box further comprises a shell, in which the rails are arranged on the shell, and the cleaning assembly is configured to be capable of reciprocating along the rails.

Further, the box body is arranged in the shell, and is detachably connected to the shell.

Further, clamping teeth which extending outward are arranged at an opening of the box body, the shell is provided with clamping grooves matched with the clamping teeth, and the box body is movably clamped and embedded in the clamping grooves by the clamping teeth.

Further, a disinfection device is arranged below the cleaning assembly.

Further, the cat litter box further comprises the shell, in which the shell comprises two side plates which are oppositely arranged, and the box body is located between the two side plates; and
a deodorization spray assembly is arranged on the inner wall of the side, facing the box body, of at least one side plate.

Further, the cat litter box further comprises a main control board and a battery, in which the battery is electrically connected to the main control board and the cleaning assembly.

Further, the cat litter box further comprises a sensing device which is electrically connected to the main control board, in which the sensing device is used for sensing whether a cat leaves the box body or not.

According to the above technical solution, the cat litter box provided by the present invention has the following advantages: a cleaning assembly capable of moving along a box body is arranged to filter cat litter in the box body, and the filtered cat litter is pushed forwards in the advancing process of the cleaning assembly; moreover, the cleaning assembly abuts against a poop basin cover when moving to the position close to a poop basin, thus the poop basin cover movably connected to the poop basin can be gradually opened along with continuous movement of the cleaning assembly, and the cat litter pushed by the cleaning assembly falls into the poop basin; moreover, the poop basin cover can be gradually closed when the cleaning assembly moves in the direction away from the poop basin; therefore, the cat litter box is automatically cleaned, and the problems that the existing cat litter box needs to be manually cleaned, which is tedious to operate and easily causes discomfort of breeders during operation.

### BRIEF DESCRIPTION OF THE DRAWINGS

In order to more clearly illustrate the technical solutions in the embodiments of the present invention or the prior art, the accompanying drawings that need to be used in the embodiments or descriptions of related technology will be briefly described below.

FIG. 1 is a schematic structural diagram before operating of a cat litter box provided by the present invention;

FIG. 2 is a schematic structural diagram of a joint of a driving mechanism and a scraper knife member provided by the present invention;

FIG. 3 is a schematic structural diagram of an operating process (a scraper knife member starts to push away a poop basin cover) of a cat litter box provided by the present invention;

FIG. 4 is a sectional view of an operating process (a scraper knife member starts to push away a poop basin cover) of a cat litter box provided by the present invention;

FIG. 5 is an enlarged diagram of a part B in FIG. 4 provided by the present invention;

FIG. 6 is a schematic structural diagram of a scraper knife member provided by the present invention;

FIG. 7 is a schematic structural diagram of an operating process (a scraper knife member completely pushes away a poop basin cover) of a cat litter box provided by the present invention;

FIG. 8 is a sectional view of an operating process (a scraper knife member completely pushes away a poop basin cover) of a cat litter box provided by the present invention;

FIG. 9 is a sectional view of an operating process (a scraper knife member is away from a poop basin cover) of a cat litter box provided by the present invention;

FIG. 10 is an enlarged diagram of a part A in FIG. 8 provided by the present invention;

FIG. 11 is a schematic structural diagram after disassembling of a cat litter box provided by the present invention; and

FIG. 12 is a schematic structural diagram of a poop basin provided by the present invention.

### DETAILED DESCRIPTION OF SOME EMBODIMENTS

The technical solution in the embodiments of the invention will be clearly and completely described below in combination with the figures in the embodiments of the invention. Obviously, the described embodiment is only a part of the embodiments of the invention, rather than all the embodiments. Based on the embodiments of the invention, all other embodiments obtained by a person skilled in the art without creative work shall fall within the protection scope of the invention.

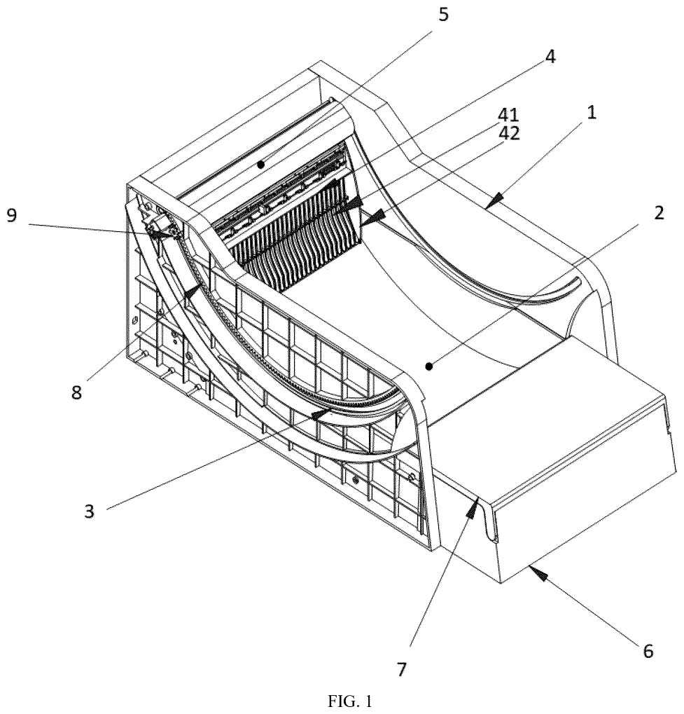

As shown in FIG. 1 to FIG. 12, it is to be understood that an embodiment provides a cat litter box, which includes a box body 2 used for accommodating cat litter, and further includes a cleaning assembly used for filtering the cat litter and a poop basin 6 used for accommodating cat poop.

The cleaning assembly is connected to the box body 2, the poop basin 6 is adjacent to the box body 2, and the cleaning assembly is configured to move towards the poop basin 6 along the end, away from the poop basin 6, of the box body 2; and during moving, the cleaning assembly will filter the cat litter in the box body 2, thus the cat poop in the cat litter can be pushed forwards as the cleaning assembly moves forwards.

The poop basin 6 is provided with a movably connected poop basin cover 7, and when the cleaning assembly moves close to the poop basin 6, the cleaning assembly will abut against the poop basin cover 7, and the poop basin cover 7 is driven to be gradually opened as the cleaning assembly moves towards the poop basin 6; when the cleaning assembly moves towards the end, away from the poop basin 6, of the box body 2, the poop basin cover 7 will be gradually closed. It is to be understood that in this process, the cat poop will be continuously moved forwards as the cleaning assembly moves towards the poop basin 6, and will fall into the poop basin 6 when the poop basin cover 7 is opened by a certain angle; and therefore, the cat litter box is automatically cleaned, and the problems that the existing cat litter box needs to be manually cleaned, which is tedious to operate and easily causes discomfort of breeders during operation can be solved.

After the cleaning assembly moves towards the end away from the poop basin 6, the poop basin cover 7 will recover to a closed state, and the cat poop is accommodated in the poop basin 6 and can be shielded by the poop basin cover 7. By this arrangement, the problem that it needs the breeder to frequently dump the cat poop is solved, and when the feeder goes out for several days or forgets to dump the cat poop on time, the cat litter in the box body 2 can be kept in a certain cleanliness; and because the removed cat poop is independently accommodated in the poop basin 6 that is kept in the closed state for a long time, the problem that the cat poop is exposed to cause air pollution or breed bacteria is solved.

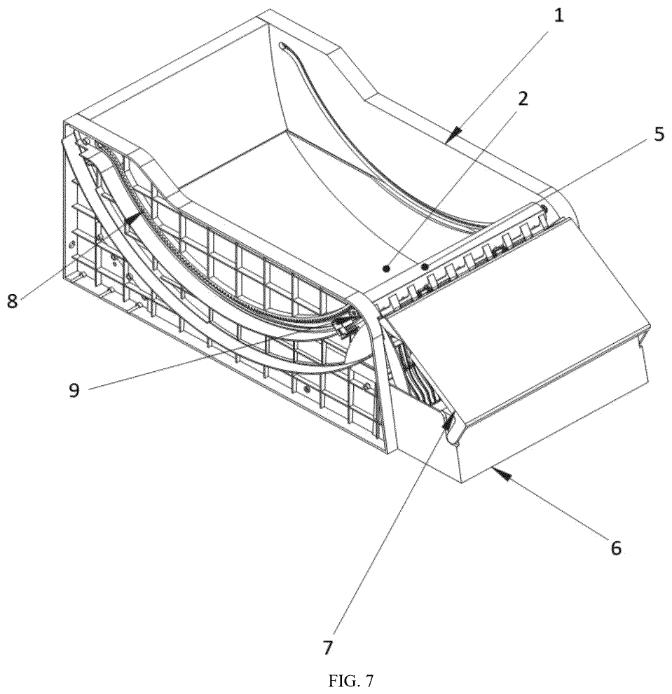

With reference to FIG. 7 to FIG. 11, further, the poop basin cover 7 includes a covering portion 71 and an abutting portion 72, in which, the covering portion 71 is movably connected to the poop basin 6; and one end of the abutting portion 72 is connected to the covering portion 71 while the other end thereof is used for abutting against the cleaning assembly. It is to be understood that when moving close to the poop basin 6, the cleaning assembly makes contact with the abutting portion 72 firstly; because the covering portion 71 is connected to the abutting portion 72, when the abutting portion 72 bears the force of the cleaning assembly to continuously move forwards, the covering portion 71 will be driven to be away from the poop basin 6, thus achieving a state that the poop basin cover 7 is opened to expose an opening of the poop basin 6. Meanwhile, the cat poop at the front end of the cleaning assembly will fall into the poop basin 6 through the opening.

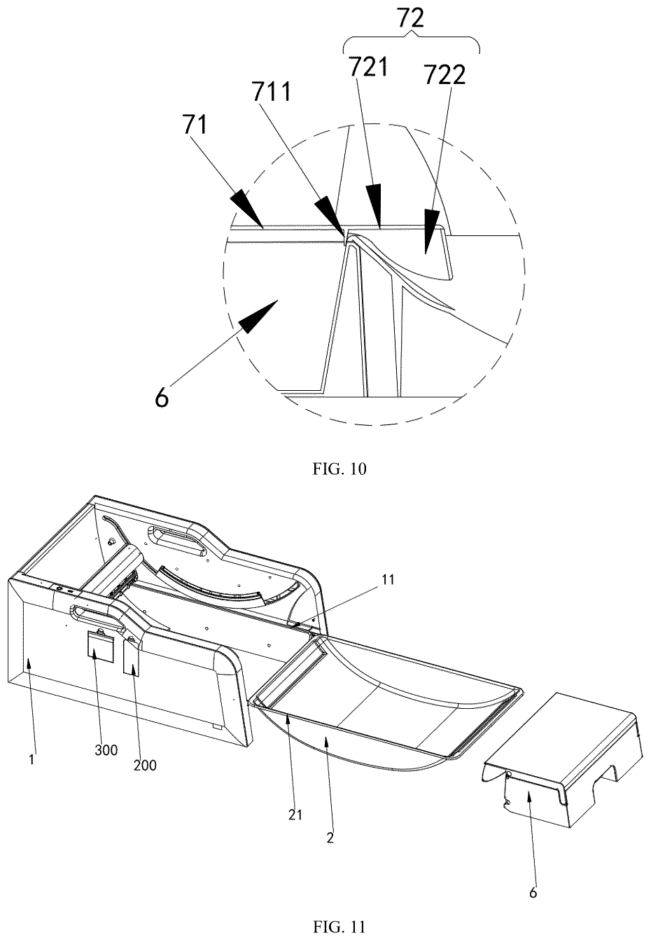

With reference to FIG. 9 to FIG. 10, further, when the poop basin cover 7 is closed, the abutting portion 72 protrudes out of the poop basin 6. In one embodiment, the covering portion 71 is arranged to be of a flat-plate-shaped structure which is matched with the opening of the poop basin 6; the abutting portion 72 includes a connecting plate 721 and an abutting plate 722, in which, the connecting plate 721 is formed by extending the covering portion 71 in the direction of the box body 2, the abutting plate 722 is formed by downwards extending the end, close to the box body 2, of the connecting plate 721, and the size of the abutting plate 722 gradually increases downwards. It is to be understood that when the cleaning assembly is close to the poop basin cover 7, the abutting plate 722 will be pushed by the cleaning assembly due to large bottom, then the connecting plate 721 and the covering portion 71 are driven to move upwards, thereby exposing the opening of the poop basin 6.

With reference to FIG. 9 to FIG. 10, in one embodiment, a separating plate 711 is arranged on the side, facing an inner chamber of the poop basin 6, of the covering portion 71; and when the poop basin cover 7 is in a closed state, the separating plate 711 is abutted against the inner wall of the poop basin 6 and is close to the opening of the poop basin 6. Further, the surfaces, close to the opening, of the separating plate 711 and the inner wall of the poop basin 6 can be wrapped with sealing structures that are made of elastic materials such as silica gel films or silica gel strips, so that the sealing effect of the poop basin 6 is further improved, and the smell of the cat poop in the poop basin 6 is isolated.

As shown FIG. 12, it is another embodiment provided by the present invention, in which, the poop basin 6 includes a poop basin frame 61 and a poop basin body 62; the poop basin cover 7 is connected to the poop basin frame 61, and the poop basin body 62 is detachably connected to the poop basin frame 61, thus a user can conveniently disassemble to dump the cat poop in the poop basin body 62, or conveniently sleeve the poop basin body 62 with a disposable storage bag; and therefore, in subsequent cleaning, the storage bag can be directly replaced, and it is not needed to clean the poop basin body 62. Exemplarily, the poop basin body 62 is set to be of a structure that has an opening in the top and is provided with an accommodating chamber; the poop basin frame 61 is provided with an opening for accommodating the poop basin body 62; the poop basin body 62 can be inserted into the opening of the poop basin frame 61 and is positioned below the poop basin cover 7 after being inserted; and when it is needed to clean the poop basin body 62, the poop basin body 62 can be directly drawn out from the opening.

Further, a detection device can be arranged on the poop basin frame 61 and is used for detecting whether the poop basin body 62 is detached or not, so that the situation that when detaching the poop basin body 62, the cat litter box is in a poop shoveling mode, and the cat poop is shoveled to the ground is avoided.

Further, the opening of the poop basin cover 7 faces the box body 2.

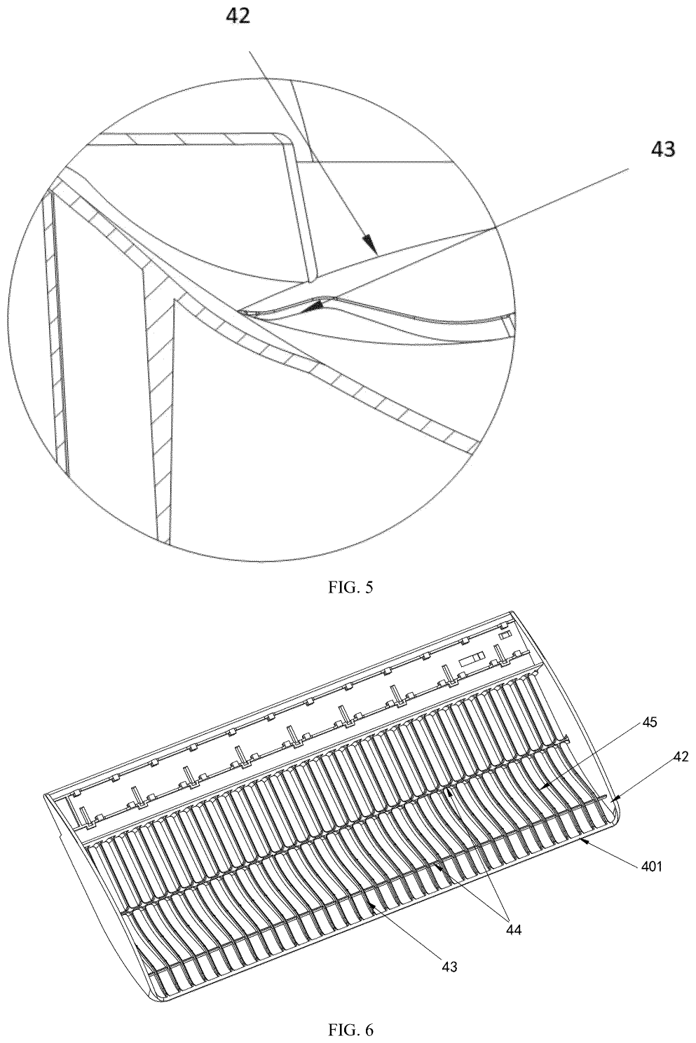

With reference to FIG. 4 to FIG. 5, further, the cleaning assembly is provided with door opening arc walls 42 which are used for being propped against the poop basin cover 7.

Further, the cleaning assembly includes a driving mechanism 5 and a scraper knife member 4 connected to the driving mechanism 5; and the driving mechanism 5 is used for driving the scraper knife member 4 to move, and the scraper knife member 4 can filter the cat litter in the box body 2 during moving.

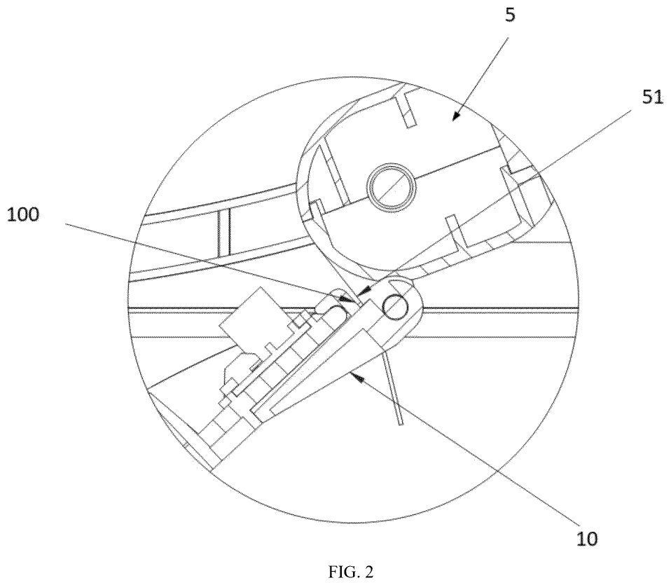

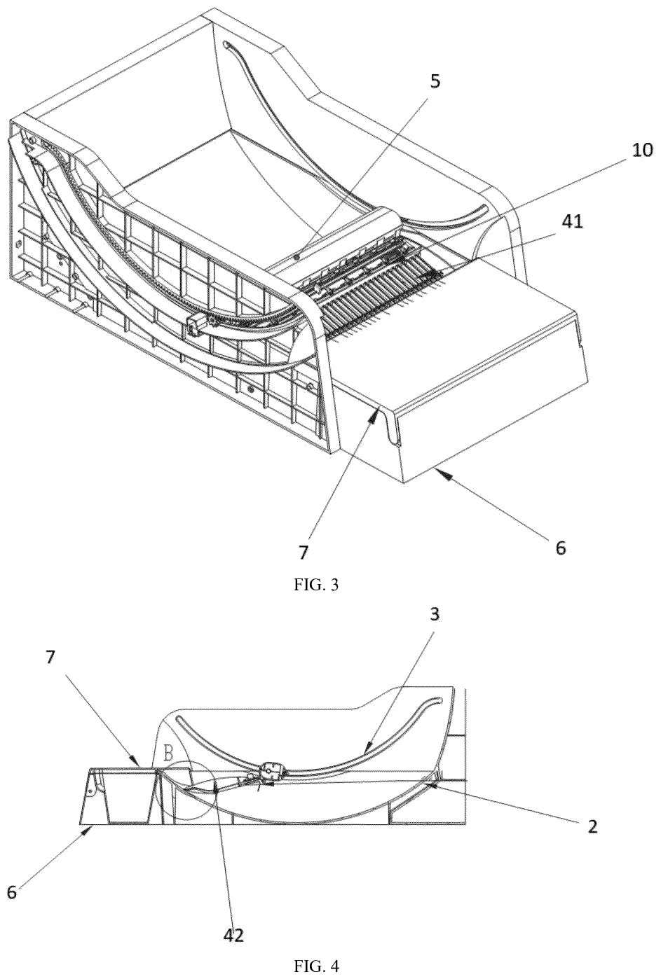

In addition, as shown in FIG. 2 to FIG. 3, the scraper knife member 4 includes a knife rest 10 which is movably connected to the driving mechanism 5; a first limiting wall 100 is arranged on the knife rest 10; and the scraper knife member 4 is detachably connected to the knife rest 10. In this embodiment, the knife rest 10 is designed on the scraper knife member 4, an upper portion of the scraper knife member 10 is axially connected to the driving mechanism 5 while a lower portion thereof is connected to the scraper knife member 4, and a locking structure is arranged between the knife rest 10 and the scraper knife member 4, so that the breeder can replace or clean the scraper knife member 4 by means of the locking structure.

With reference to FIG. 4 to FIG. 6, further, the door opening arc walls 42 are arranged on two sides of the scraper knife member 4 and are higher than the scraper knife member 4.

With reference to FIG. 6, further, the scraper knife member 4 is provided with a first scraper knife portion 401 which is abutted against the box body; in the process that the driving mechanism 5 drives the scraper knife member 4 to move, the first scraper knife portion 401 fits an upper surface of the box body 2 to move. Specifically, the scraper knife member 4 is provided with a first blade set that is parallel to the scraper knife member 4 in the moving direction; the first blade set includes a plurality of single blade bodies 43 arranged at intervals; and the first scraper knife portion 401 is fixed to the tail ends, close to the box body 2, of all the single blade bodies 43. The first scraper knife portion 401 can be arranged to be of a sheet-shaped structure.

With reference to FIG. 6, in one embodiment, the plurality of single blade bodies 43 are connected by means of a second blade set, and the second blade set includes a plurality of separation blades 44 which are connected to the plurality of single blade bodies at the same time. By this arrangement, when the scraper knife member 4 moves, the first scraper knife portion 401 will fit the upper surface of the box body 2 to move, thus the cat litter in the box body 2 can be shoveled away from the box body 2 by the first scraper knife portion 401 and then fall into a blade net consisting of the first blade set and the second blade set, large cat poop will be filtered out and left above the blade net, small cat litter particles will fall back into the box body 2 by the blade net, thus achieving the effect of filtering cat poop masses.

With reference to FIG. 6, further, each blade single body 43 is provided with at least one concave portion, the concave portions of the plurality of single blade bodies 43 jointly form bearing portions 45 for the cat poop to temporarily stay; when in operating, the first scraper knife portion 401 is used for shoveling the cat poop away from the bottom of the box body 2, then the cat poop will move to the surface of the cat litter as the scraper knife member 4 moves backwards and then forwards; then as the scraper knife member 4 moves forwards, the cat poop will be kept on the bearing portions 45 composed of the concave portions of the plurality of single blade bodies 43, thus the cat poop cannot be accumulated in front of the first shovel knife portion 401 that is in contact with the bottom of the box body 2 for a long time; because the bearing portions 45 are high, the cat poop will be higher than the cat litter during being pushed away, so the cat litter cannot be pushed away; on the contrary, if the bearing portions 45 are not arranged, the cat litter will be gathered in front of the first scraper knife portion 401, and more cat litter will be pushed away.

In an actual use scenario, cat urine enters the cat litter box, because it is liquid, it may quickly flow to the bottom of the box (if the cat litter cannot absorb it in time), and spread at the bottom of the box, and then it is absorbed by the cat litter and is agglomerated; in this case, the urine masses completely adhere to the bottom of the box and have high adhesion force; even if the user manually shovels the urine masses, it is difficult to remove, and this problem cannot be solved by various cat litter boxes in the related technology. For example, when cat feces or cat urine is agglomerated with the cat litter and then adheres to the bottom of the box body 2, in the related technology, a rake-shaped or comb-shaped cleaning claw is adopted, which easily breaks, cuts and damages the cat urine masses and cat poop masses into scattered blocks, and the scattered blocks still adhere to the bottom of the basin; or even if they do not adhere to the bottom of the box, they still cannot be filtered out due to size reduced by breaking, and finally the cat poop masses and cat poop masses remain in the box body and are mixed with the cat litter, resulting in a situation that the cat poop mass is not completely cleaned.

According to the technical solution in this embodiment that the scraper knife member 4 and the box body 2 are arranged in a fitting way, when the scraper knife member 4 moves from one end to the other end of the box body 2, the first scraper knife portion 401 will shovel or scrape the bottom of the box body 2, thus a better cleaning effect can be achieved when the cat poop masses adhere to the bottom of the box body 2.

In one embodiment, the scraper knife member 4 and the door opening arc walls 42 can be manufactured by an integrated molding technology.

As shown in FIG. 5 to FIG. 8, when the scraper knife member 4 arrives at the front end of the box body 2, the door opening arc walls 42 on the two ends of the scraper knife member 4 will push away the poop basin 7, and as the scraper knife member 4 continues to move forwards, and the poop basin 7 will be pushed away more; as shown in FIG. 5 to FIG. 7, when the scraper knife member 4 crosses the front end of the box body 2, the scraper knife member 4 will incline downwards by means of the torsional spring and gravity until the cat poop masses are completely dumped.

When the scraper knife member 4 returns, because an upward angle is fixed by the first limiting wall 100 and the second limiting wall 51, the scraper knife member 4 will level the cat litter and returns to the initial position under the pressure of the torsional spring. At the moment, the poop basin cover 7 will cover the poop basin 6 and achieves a certain sealing performance, thereby preventing the smell from flowing outside.

With reference to FIG. 1 to FIG. 11, in one embodiment, the cat litter box further includes a shell 1; and rails 3 are arranged on the shell 1, and the cleaning assembly is configured to be capable of reciprocating along the rails 3.

Further, the driving mechanism 5 in the cleaning assembly is in sliding connection with the rails 3 by sliding rail members and is configured to be capable of reciprocating along the rails 3.

Further, racks 8 are arranged in the rails 3, and the sliding rail members are arranged to be gears 9 in meshed connection with the racks 8. The racks 8 and the gears 9 are meshed, so that the driving mechanism 5 can evenly slide on the rails 3. Exemplarily, two sets of rails 3 are provided and are arranged on the two sides of the box body 2 respectively, and the tooth positions of the racks 8 of the rails on the two sides correspond to each other one by one; adaptively, two sets of gears 9 are arranged and connected to two ends of the driving mechanism 5 respectively so that the driving mechanism 5 can stably run when moving forwards along the racks 8 by means of the gears 9, that is, the scraper knife member 4 can stably scrape and filter the cat litter in the box body 2 at a constant speed, thus achieving the purpose of even cleaning.

Further, the bottoms of the rails 3 and the bottom of the box body 2 are both in an arc shape, and the rails 3 and the box body 2 have the same the bending radian and are corresponding in position. According to the design of the cat litter box with the arc-shaped bottom and the first scraper knife portion 401 making contact with the basin bottom all the time, it is needed to scrape the poop from the box bottom, in the whole poop scraping process, the first scraper knife portion 401 performs shoveling on the arc-shaped bottom surface all the time, and therefore the cat poop can be effectively scraped out from the cat litter; and moreover, the clean cat litter can be filtered out by the blade net consisting of the first blade set and the second blade set, thereby achieving a good cleaning effect.

In this embodiment, the box body 2 is used for accommodating the cat litter, and the scraper knife member 4 is used for shoveling out the cat poop after the cat defecates; particularly, the rails 3 are arranged on the shell 1 and used for guiding the driving mechanism 5 to slide, and as the driving mechanism 5 slides, the connected scraper knife member 4 is driven to move so as to clean the cat poop. In this embodiment, the bottom of the inner chamber of the box body 2 is designed to be in an arc shape which facilitating the fitting of the scraper knife member 4, and therefore when in work, the scraper knife member 4 can fit the bottom of the box body 2 all the time; in order to make the scraper knife member 4 completely fit the bottom of the cat litter box, the rails 3 that push the driving mechanism 5 to move are also designed to be in a corresponding arc shape, thus the shoveling-in angle is completely the same when the scraper knife member 4 performs shoveling, and the scraper knife member 4 can completely fit the bottom of the box body 2 in the moving process.

Because of the fitting of the scraper knife member 4 and the bottom of the box body 2, the scraper knife member 4 can shovel to thoroughly clean the box body 2 in the forward moving process, and thus the problem that the cat poop or cat urine is agglomerated with the cat litter and then adheres to the bottom of the box body 2 is solved.

Exemplarily, the driving mechanism 5 can be of a motor structure and is driven by the motor structure. An anti-collision safety rod 501 is arranged at the end of the driving mechanism 5 and can achieve an anti-collision effect when the driving mechanism 5 moves to the end away from the poop basin.

With reference to FIG. 1 to FIG. 2, further, the scraper knife member 4 is rotationally connected to the driving mechanism 5, and the torsion structure is arranged at the joint of the scraper knife member 4 and the driving mechanism 5; the first limiting wall 100 is arranged at one end of the scraper knife member 4, the second limiting wall 51 is correspondingly arranged on the driving mechanism 5, and when the scraper knife member 4 rotates relative to the driving mechanism 5, the first limiting wall 100 can be abutted against the second limiting wall 51; and the direction in which the first limiting wall 100 abuts against the second limiting wall 51 is opposite to the torsion direction of the torsion structure.

Further, the torsion structure can be a torsion spring. In other embodiments, the torsion structure can also be a spring sheet or a column type spring.

In addition, as shown in FIG. 2, if the torsion structure is the torsional spring, a tip of the scraper knife member 4 can be pressed downwards by torsion, then the scraper knife member 4 can tightly fit the bottom of the box body 2 during moving forwards, and thus the cat poop can be shoveled as much as possible.

In another aspect, the first limiting wall 100 is arranged above the scraper knife member 4, and the second limiting wall 51 is arranged on the driving mechanism 5; due to the abutting of the first limiting wall 100 and the second limiting wall 51, the cat litter in the box body 2 can be kept flat after poop shoveling, and the cat litter in the box body 2 can be evenly distributed, which facilitates the cat to defecate next time. Specifically, when the scraper knife member 4 is driven by the driving mechanism 5 to arrive at the poop basin 6 to perform the work of shoveling feces, filtering the cat litter, and making the cat poop into the poop basin 6, the driving mechanism 5 will drive the scraper knife member 4 to return to the initial position, and in the returning process, the scraper knife member 4 can rotate upwards by the cat litter in the box body 2, but due to the propping of the first limiting wall 100 and the second limiting wall 51, the angle of the scraper knife member 4 is limited, the scraper knife member 4 cannot rotate upwards without limitation, and therefore in the process that the scraper knife member 4 returns to the starting point, the scraper knife member 4 can press the cat litter to be flat.

With reference to FIG. 1 to FIG. 11, further, the box body 2 is arranged in the shell 1 in a detachable connection way, which facilitates the user to take out the box body 2 for cleaning. Or, if the box body 2 is damaged, the box body 2 can be independently replaced, rather than replacing the whole cat litter box.

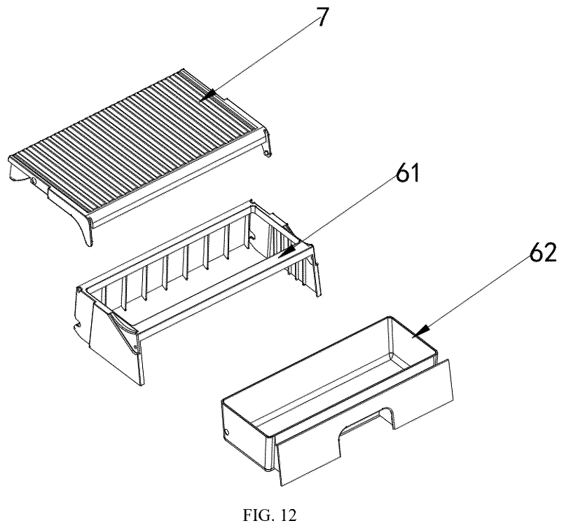

With reference to FIG. 11, further, clamping teeth 21 which extend outward are arranged at the opening of the box body 2, the shell 1 is provided with clamping grooves 11 which are matched with the clamping teeth 21, and the box body 2 is movably clamped and embedded in the clamping grooves 11 by the clamping teeth 21.

Further, a disinfection device is arranged below the cleaning assembly. The disinfection device can be an ultraviolet disinfection lamp for performing ultraviolet disinfection on the box body 2, the cat litter and the like.

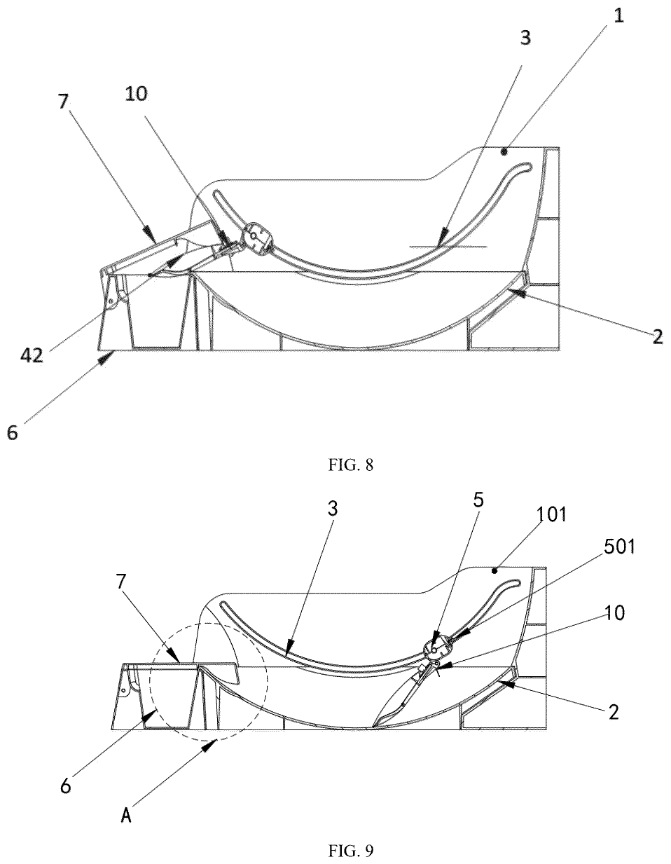

With reference to FIG. 8 and FIG. 11, further, the cat litter box further includes the shell 1, and the shell 1 includes two side plates 101 which are oppositely arranged, and the box body 2 is located between the two side plates 101; and a deodorization spray assembly 200 is arranged on the inner wall of the side, facing the box body 2, of at least one side plate 101. The deodorization spray assembly 200 can be set to be started after the cat finishes defecation and leaves the cat litter box and before the cleaning assembly shovels the poop, so that the deodorization spray assembly 200 can remove smell of the cat poop before poop shoveling, thereby preventing the smell from spreading in the poop shoveling process. Or, the deodorization spray assembly 200 can also be set to be used for regularly injecting deodorization spray into the box body 2 at a set time interval when the cat does not defecate and it is not operated to shovel poop, so that the smell of the cat litter box can be reduced as much as possible, the air around the cat litter box is kept fresh, and the problem that the cat repels due to strong smell of the cat litter box is solved.

Further, the cat litter box further includes a main control board and a battery 300, and the battery 300 is electrically connected to the main control board and the cleaning assembly. The poop shoveling mode of the cat litter box can be controlled and adjusted by means of the main control board.

Further, the battery 300 is detachably connected to the cat litter box. The battery 300 can be taken down and charged, and by this function, the cat litter box can independently work even if being far away from a power supply.

Further, the cat litter box further includes a sensing device which is electrically connected to the main control board, and the sensing device is used for sensing whether the cat leaves the box body 2 or not; and when the sensing device senses that the cat comes, the cat poop shoveling mode will be started after a set delay time (the absorption time of cat litter).

The above is only an optional embodiment of the present invention, and does not limit the patent scope of the present invention, and all equivalent structural transformations made by using the contents of the description and drawings of the present invention under the conception of the present invention, or directly or indirectly used in other related technical fields are included in the patent protection scope of the present invention.

What is claimed is:

1. A cat litter box, comprising a box body, further comprising a cleaning assembly and a poop basin, wherein the cleaning assembly is connected to the box body, the poop basin is adjacent to the box body, and the cleaning assembly is configured to move towards the poop basin along the end, far away from the poop basin, of the box body; during moving, the cleaning assembly filters cat litter in the box body; and
the poop basin is provided with a movably connected poop basin cover, and when the cleaning assembly moves close to the poop basin, the cleaning assembly is abutted against the poop basin cover, and then the poop basin cover is driven to be gradually opened as the cleaning assembly moves towards the poop basin; and when the cleaning assembly moves towards the end, far away from the poop basin, of the box body, the poop basin cover is gradually closed.

2. The cat litter box according to claim 1, wherein the poop basin cover comprises a covering portion and an abutting portion; the covering portion is movably connected to the poop basin; and one end of the abutting portion is connected to the covering portion while the other end thereof is used for abutting against the cleaning assembly.

3. The cat litter box according to claim 2, wherein when the poop basin cover is closed, the abutting portion protrudes out of the poop basin.

4. The cat litter box according to claim 1, wherein the poop basin comprises a poop basin frame and a poop basin body, the poop basin cover is connected to the poop basin frame, and the poop basin body is detachably connected to the poop basin frame.

5. The cat litter box according to claim 1, wherein the cleaning assembly is provided with door opening arc walls which are used for being abutted against the poop basin cover.

6. The cat litter box according to claim 5, wherein the cleaning assembly comprises a driving mechanism and a scraper knife member connected to the driving mechanism; and the driving mechanism is used for driving the scraper knife member to move, so that the scraper knife member can filter the cat litter in the box body during moving.

7. The cat litter box according to claim 6, wherein the door opening arc walls are arranged on two sides of the scraper knife member, and are higher than the scraper knife member.

8. The cat litter box according to claim 6, wherein the scraper knife member is provided with a first scraper knife portion which is abutted against the box body; and
in the process that the driving mechanism drives the scraper knife member to move, the first scraper knife portion fits an upper surface of the box body to move.

9. The cat litter box according to claim 6, further comprising a shell, wherein rails are arranged on the shell which is in sliding connection with the driving mechanism by sliding rail members; and the driving mechanism is configured to be capable of reciprocating along the rails.

10. The cat litter box according to claim 9, wherein racks are arranged in the rails, and the sliding rail members are arranged to be gears in meshed connection with the racks.

11. The cat litter box according to claim 9, wherein the bottoms of the rails and the bottom of the box body are both in an arc shape, and the rails and the box body have the same bending radian and are corresponding in position.

12. The cat litter box according to claim 10, wherein the scraper knife member is rotationally connected to the driving mechanism, and a torsion structure is arranged at a joint of the scraper knife portion and the driving mechanism; a first limiting wall is arranged at one end of the scraper knife member, and a second limiting wall is correspondingly arranged on the driving mechanism; the first limiting wall can be abutted against the second limiting wall when the scraper knife member rotates relative to the driving mechanism; and the direction in which the first limiting wall abuts against the second limiting wall is opposite to the torsion direction of the torsion structure.

13. The cat litter box according to claim 12, wherein the torsion structure is a torsion spring.

14. The cat litter box according to claim 1, further comprising a shell, wherein the rails are arranged on the shell, and the cleaning assembly is configured to be capable of reciprocating along the rails.

15. The cat litter box according to claim 9, wherein the box body is arranged in the shell, and is detachably connected to the shell.

16. The cat litter box according to claim 15, wherein clamping teeth which extending outward are arranged at an opening of the box body, the shell is provided with clamping grooves matched with the clamping teeth, and the box body is movably clamped and embedded in the clamping grooves by the clamping teeth.

17. The cat litter box according to claim 1, wherein a disinfection device is arranged below the cleaning assembly.

18. The cat litter box according to claim 1, further comprising the shell, wherein the shell comprises two side plates which are oppositely arranged, and the box body is located between the two side plates; and
a deodorization spray assembly is arranged on the inner wall of the side, facing the box body, of at least one side plate.

19. The cat litter box according to claim 1, further comprising a main control board and a battery, wherein the battery is electrically connected to the main control board and the cleaning assembly.

20. The cat litter box according to claim 19, further comprising a sensing device which is electrically connected to the main control board, wherein the sensing device is used for sensing whether a cat leaves the box body or not.
